(19) United States
(12) Patent Application Publication
(10) Pub. No.: US 2013/0039257 A1
(43) Pub. Date: Feb. 14, 2013

(54) Method of Handling Handover of a Relay Node and Related Communication Device

(71) Applicant: Te-Ming Chen, Taoyuan County (TW)

(72) Inventor: Te-Ming Chen, Taoyuan County (TW)

(21) Appl. No.: 13/571,335

(22) Filed: Aug. 9, 2012

Related U.S. Application Data
(60) Provisional application No. 61/522,679, filed on Aug. 11, 2011.

(51) Int. Cl. H04W 36/38

(52) U.S. Cl. 370/315

(57) ABSTRACT

A method of handling a handover for a relay node (RN) in a wireless communication system is disclosed. The method comprises receiving a handover command transmitted from a source donor evolved Node-B (DeNB) of the wireless communication system; and releasing an RN subframe configuration after receiving the handover command, if the RN is in a connected mode.

### CROSS REFERENCE TO RELATED APPLICATIONS

This application claims the benefit of U.S. Provisional Application No. 61/522,679, filed on Aug. 11, 2011 and entitled “Relay node behaviours for handover”, the contents of which are incorporated herein in their entirety.

### BACKGROUND OF THE INVENTION

1. Field of the Invention

The present invention relates to a method used in a wireless communication system and related communication device, and more particularly, to a method of handling a handover of a relay node and related communication device.

2. Description of the Prior Art

A long-term evolution (LTE) system supporting the 3GPP Rel-8 standard and/or the 3GPP Rel-9 standard are developed by the 3rd Generation Partnership Project (3GPP) as a successor of a universal mobile telecommunications system (UMTS), for further enhancing performance of the UMTS to satisfy increasing needs of users. The LTE system includes a new radio interface and a new radio network architecture that provides a high data rate, low latency, packet optimization, and improved system capacity and coverage. In the LTE system, a radio access network known as an evolved universal terrestrial radio access network (E-UTRAN) includes multiple evolved Node-Bs (eNBs) for communicating with multiple UEs , and communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at coverage edge of an eNB, and includes advanced techniques, such as carrier aggregation (CA), coordinated multipoint transmission/reception (COMP), UL multiple-input multiple-output (MIMO), etc. For a UE and an eNB to communicate with each other in the LTE-A system, the UE and the eNB must support standards developed for the LTE-A system, such as the 3GPP Rel-10 standard or later versions.

Furthermore, relay nodes (RNs) can be deployed in the LTE system and the LTE-A system, for improving coverage of eNBs. In general, the RNs are divided into multiple groups for ease of management, and each group of the RNs is managed by an eNB which is denoted as the donor eNB (DeNB). Due to resource (re)allocation or movement of a RN, the RN may hand over from a source DeNB to a target DeNB. In this situation, system information used for communicating with the source DeNB may not be valid for the target DeNB. Besides, since the RN is allocated with a RN subframe configuration by the source DeNB (e.g., the RN is in a connected mode), the RN will not try to acquire a valid version of the system information (e.g., on a broadcast channel) according to the prior art. Thus, the RN cannot communicate with the target DeNB after handing over to the target DeNB. Therefore, how to solve the problem of handover of an RN is a topic to be discussed.

### SUMMARY OF THE INVENTION

The present invention therefore provides a method and related communication device for handling a handover of a relay node (RN) to solve the abovementioned problem.

A method of handling a handover for a relay node (RN) in a wireless communication system is disclosed. The method comprises receiving a handover command transmitted from a source donor evolved Node-B (DeNB) of the wireless communication system; and releasing an RN subframe configuration after receiving the handover command, if the RN is in a connected mode.

A method of handling a handover of a relay node (RN) in a wireless communication system for a source donor evolved Node-B (DeNB) of the wireless communication system is disclosed. The method comprises transmitting all system information required for a connected mode to the RN in the connected mode, when the RN prepares to hand over from the source DeNB to a target DeNB of the wireless communication system.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example the present invention.

FIG. 2 is a schematic diagram of a communication device according to an example to the present invention.

FIG. 3 is a flowchart of a process according to an example of the present invention.

FIG. 4 is a flowchart of a process according to an example of the present invention.

### DETAILED DESCRIPTION

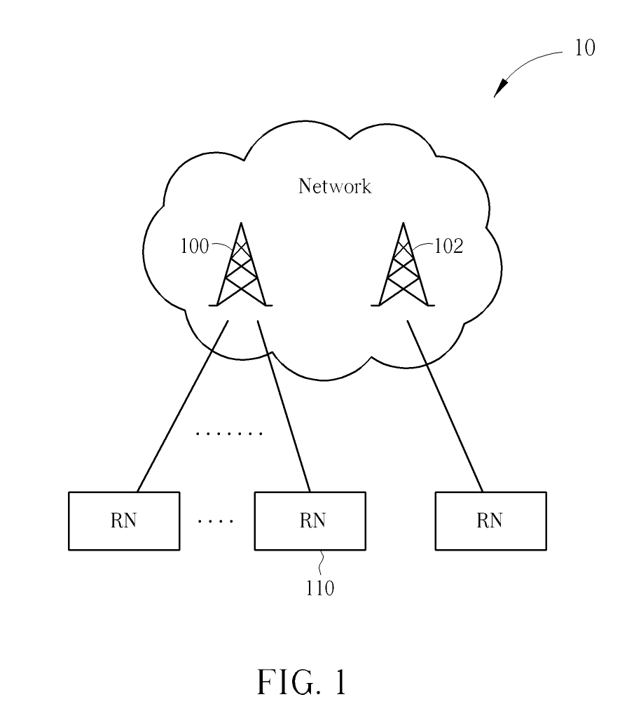

Please refer to FIG. 1, which is a schematic diagram of a wireless communication system 10 according to an example of the present invention. The wireless communication system 10 is briefly composed of a plurality of relay nodes (RNs) and a network. The wireless communication system 10 can be an orthogonal frequency division multiplexing (OFDM) system and/or an orthogonal frequency division multiple access (OFDMA) system, such as a long term evolution (LTE) system, a LTE-Advanced (LTE-A) system or a successor of the LTE-A system. Please note that, the RNs and the network are simply utilized for illustrating a structure of the wireless communication system 10. Practically, the network can be referred to as an evolved UTRAN (E-UTRAN) comprising evolved NodeBs (eNBs) in the LTE system or the LTE-A system, and are not limited herein.

In detail, two eNBs 100 and 102 of the network may be donor eNBs (DeNBs), and each of the DeNBs 100 and 102 manages (i.e., controls) one or more RNs. For example, the DeNB 100 can allocate resource to an RN 110, or can trigger the RN 110 to handover from the DeNB 100 to the DeNB 102. Besides, the network (i.e., the DeNBs) and an RN (e.g., the RN 110) can be seen as a transmitter or a receiver according to transmission directions, e.g., for an uplink (UL), the RN is the transmitter and the network is the receiver, and for a downlink (DL), the network is the transmitter and the RN is the receiver.

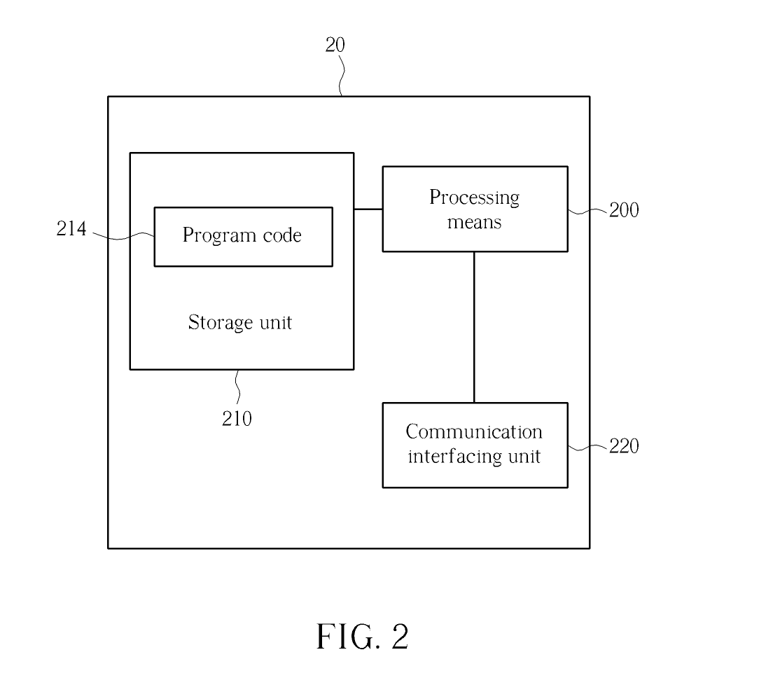

Please refer to FIG. 2, which is a schematic diagram of a communication device 20 according to an example of the present invention. The communication device 20 can be a RN (e.g., the RN 110) or the network (i.e., the DeNBs 100 and 102) shown in FIG. 1, but is not limited herein. The communication device 20 may include a processing means 200 such as a microprocessor or an Application Specific Integrated Circuit (ASIC), a storage unit 210 and a communication interfacing unit 220. The storage unit 210 may be any data storage device that can store a program code 214, accessed by the processing means 200. Examples of the storage unit 210 include but are not limited to a subscriber identity module (SIM), read-only memory (ROM), flash memory, random-access memory (RAM), CD-ROM/DVD-ROM, magnetic tape, hard disk, and optical data storage device. The communication interfacing unit 220 is preferably a radio transceiver, and can transmit and receive wireless signals according to processing results of the processing means 200.

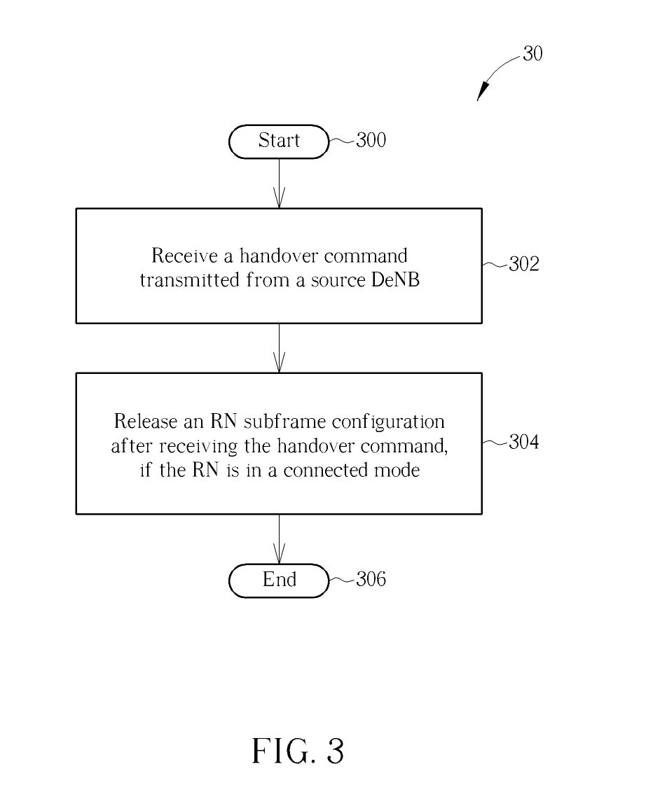

Please refer to FIG. 3, which is a flowchart of a process 30 according to an example of the present invention. The process 30 is utilized in the RN 110 shown in FIG. 1, for handling a handover of the RN 110. The process 30 maybe compiled into the program code 214, and includes the following steps:

Step 300: Start.

Step 302: Receive a handover command transmitted from a source DeNB.

Step 304: Release an RN subframe configuration after receiving the handover command, if the RN is in a connected mode.

Step 306: End.

According to the process 30, after receiving a handover command transmitted from a source DeNB as the DeNB 100, the RN 110 releases an RN subframe configuration if the RN is in a connected mode. Preferably, the handover command is an RRC connection reconfiguration message “RRCConnectionReconfiguration” including mobility control information as an information element (IE) “mobilityControllnfo”. Thus, the RN 110 can acquire system information transmitted from a target DeNB as the DeNB 102 (e.g., on a broadcast channel), after handing over from the DeNB 100 to the DeNB 102. As a result, when the RN 110 does not have a valid version of the system information after handing over from the DeNB 100 to the DeNB 102, the RN 110 can acquire the valid version of the system information from the DeNB 102 by a way of releasing the RN subframe configuration. Preferably, the system information comprises a master information block (MIB), a system information block (SIB) Type 1 and/or a SIB Type 2 which are system information required for communicating with the DeNB 102.

Thus, according to the process 30 and the above description, the RN 110 can communicate with the target DeNB regularly by using the system information, after performing a handover. The problem that an RN cannot acquire system information when the handover occurs in the connected mode is solved.

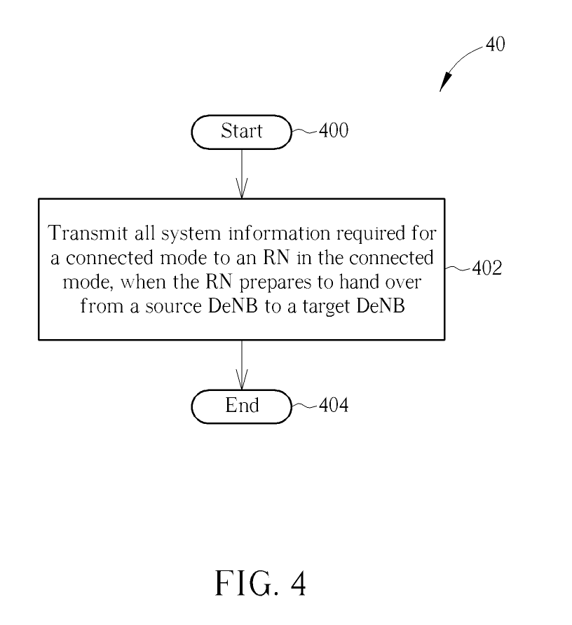

Please refer to FIG. 4, which is a flowchart of a process 40 according to an example of the present invention. The process 40 is utilized in a source DeNB of the network shown in FIG. 1, for handling a handover of the RN 110. The process 40 may be compiled into the program code 214, and includes the following steps:

Step 400: Start.

Step 402: Transmit all system information required for a connected mode to an RN in the connected mode, when the RN prepares to hand over from a source DeNB to a target DeNB.

Step 404: End.

According to the process 40, a source DeNB as the DeNB 100 transmits all system information required for the connected mode to the RN 110 in the connected mode, when the RN 110 prepares to hand over from the DeNB 100 to a target DeNB as the DeNB 102. That is, the RN 110 in the connected mode does not need to look for the system information on a broadcast channel, but the DeNB 100 actively transmits all the system information required for the connected mode to the RN 110 in the connected mode. Thus, the RN 110 can communicate with the DeNB 102 by using the received system information, after handing over from the DeNB 100 to the DeNB 102. Preferably, the system information comprises a MIB, a SIB Type 1 and/or a SIB Type 2 which are system information required for communicating with the DeNB 102.

Please note that, a method according to which the system information is transmitted is not limited. The source DeNB in the network can transmit the system information required for the connected mode to the RN 110 in the connected mode by transmitting an RN configuration message or a handover command comprising all the system information required for the connected mode to the RN 110 in the connected mode. In detail, when the source DeNB transmits the handover command which is an RRC connection reconfiguration message “RRCConnectionReconfiguration” including mobility control information as an IE “mobilityControllnfo” to the RN 110 in the connected mode, the source DeNB includes the system information required for the connected mode in the handover command, for providing the system information to the RN 110 in the connected mode. Alternatively, the DeNB 100 can include the system information required for the connected mode in the RN configuration message, for providing the system information to the RN 110.

Thus, according to the process 40 and the above description, the RN 110 can communicate with the target DeNB regularly after performing a handover. The problem that an RN can not acquire system information when the handover occurs in the connected mode is solved.

Those skilled in the art should readily make combinations, modifications and/or alterations on the abovementioned examples. The abovementioned steps of the processes including suggested steps can be realized by means that could be a hardware, a firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include a system on chip (SOC), system in package (SiP), a computer on module (COM), and the communication device 20.

To sum up, the present invention provides methods for solving the problem that an RN cannot acquire system information when a handover occurs in the connected mode. According to the present invention, the system information can be acquired by the RN itself after releasing an RN subframe configuration, or can be provided by the network to the RN. Thus, the problem of the handover is solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of handling a handover for a relay node (RN) in a wireless communication system, the method comprising:
receiving a handover command transmitted from a source donor evolved Node-B (DeNB) of the wireless communication system; and
releasing an RN subframe configuration after receiving the handover command, if the RN is in a connected mode.

2. The method of claim 1, wherein the handover command is an RRC connection reconfiguration message
“RRCConnectionReconfiguration” including mobility control information as an information element “mobilityControllnfo”.

3. The method of claim 1, further comprising:
acquiring system information transmitted from a target DeNB of the wireless communication system, after handing over from the source DeNB to the target DeNB.

4. The method of claim 3, wherein the RN does not have a valid version of the system information, before obtaining the system information transmitted from the target DeNB.

5. The method of claim 3, wherein the system information comprises at least one of a master information block (MIB), a system information block (SIB) Type 1 and a SIB Type 2.

6. A method of handling a handover of a relay node (RN) in a wireless communication system for a source donor evolved Node-B (DeNB) of the wireless communication system, the method comprising:
transmitting all system information required for a connected mode to the RN in the connected mode, when the RN prepares to hand over from the source DeNB to a target DeNB of the wireless communication system.

7. The method of claim 6, wherein the source DeNB transmits all the system information required for the connected mode to the RN in the connected mode by transmitting an RN configuration message or a handover command comprising all the system information to the RN.

8. The method of claim 7, wherein the handover command is an RRC connection reconfiguration message
“RRCConnectionReconfiguration” including mobility control information as an information element “mobilityControllnfo”.

9. The method of claim 6, wherein the system information comprises at least one of a master information block (MIB), a system information block (SIB) Type 1 and a SIB Type 2.
